(19) United States
(12) Patent Application Publication
(10) Pub. No.: US 2008/0094849 A1
(43) Pub. Date: Apr. 24, 2008

(54) BACKLIGHT MODULE AND SUPPORTING DEVICE THEREOF

(75) Inventor: Shao-An Lu, Bade City (TW)

Correspondence Address: SNELL & WILMER L.L.P., One Arizona Center, 400 East Van Buren, Phoenix, AZ, 85004-2202, US

(73) Assignee: DARFON ELECTRONICS CORP, Taoyuan (TW)

(21) Appl. No.: 11/873,722

(22) Filed: Oct. 17, 2007

(30) Foreign Application Priority Data
Oct. 18, 2006 (TW) 95138411
Nov. 1, 2006 (TW) 95140405

(51) Int. Cl. F21V 21/088

(52) U.S. Cl. 362/396

(57) ABSTRACT

A backlight module and a supporting device thereof are provided. The supporting device includes a first housing having an engaging part, a second housing having an opening for receiving the lamp, and an elastic mechanism disposed in the seconding housing. The first housing and the second housing are foldably connected. When the first housing and the second housing are folded, the engaging part compresses the elastic mechanism to electrically clamp the lamp.

### CROSS REFERENCE TO RELATED APPLICATIONS

This application claims the right of priority based on Taiwan Patent Application No. 095138411 entitled “BACKLIGHT MODULE AND THE SUPPORTING DEVICE THEREOF,” filed on Oct. 18, 2006, and Taiwan Patent Application No. 095140405 entitled “BACKLIGHT MODULE AND THE SUPPORTING DEVICE THEREOF,” filed on Nov. 1, 2006, which are incorporated herein by reference and assigned to the assignee herein.

### FIELD OF INVENTION

The present invention generally relates to a backlight module and a supporting device thereof and, more particularly, to a backlight module with a supporting device for sustaining a lamp and electrically connecting the lamp with a printed circuit board.

### BACKGROUND OF THE INVENTION

The assembly of a conventional liquid crystal display device, such as LCD television (LCD TV), generally involves manually welding lamps of a back light module, and then through common connectors, electrically connecting the lamps to a printed circuit board so that the lamps can be provided with power for illumination.

However, during the assembly of the conventional backlight module, the connections among lamps, the connector, and the printed circuit board completed by a manual welding process generally produce contaminations on the welding points. The contaminations may cause the voltage variation of the backlight module, which downgrades the quality and stability of the backlight module. Furthermore, the welding connections of the lamps, the connectors, and the printed circuit board of the backlight module usually require more process time, and accordingly increase the production cost.

Therefore, it is a desired to provide a backlight module with a supporting device, which electrically connects the lamp by a mechanical design instead of a welding process.

### SUMMARY OF THE INVENTION

In view of the drawbacks of the prior art, one aspect of the present invention is to provide a backlight module and a supporting device thereof, so that the assembly cost can be reduced and the quality can be improved.

Another aspect of the present invention is to provide a supporting device for sustaining a lamp. The supporting device includes a first housing and a second housing integrally formed and foldably connected so as to reduce discrete elements and in turn, the assembly cost.

A further another aspect of the present invention is to provide a supporting device with an elastic mechanism for electrically connecting a lamp and a printed circuit board so as to lessen the need of welding processes and to reduce the processing time and the manufacture cost.

Another aspect of the present invention is to provide a supporting device with a positioning mechanism, so that the supporting device can be fixed onto a printed circuit board to improve the capability of sustaining a lamp, instead of using a solder connection.

In one embodiment of the present invention, a backlight module includes a lamp and a supporting device for sustaining the lamp. The supporting device includes a first housing having an engaging part, a second housing having an opening for receiving the lamp, and an elastic mechanism disposed in the second housing. The second housing is foldably connected with the first housing. When the first housing and the second housing are folded, the engaging part compresses the elastic mechanism to clamp the lamp so that the lamp can be electrically coupled with a printed circuit board.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a schematic view of a supporting device in accordance with one embodiment of the present invention;

FIGS. 2A and 2B illustrate schematic views of an exemplary elastic mechanism and a printed circuit board in accordance with one embodiment of the present invention;

FIGS. 3A and 3B illustrate schematic views of assembling a lamp, a supporting device, and a printed circuit board in accordance with another embodiment of the present invention;

FIG. 4A illustrates a schematic view of disassembling a lamp, a supporting device, an elastic mechanism, and a printed circuit board in accordance with one embodiment of the present invention;

FIG. 4B illustrates a schematic view of assembling a lamp, a supporting device, an elastic mechanism, and a printed circuit board of FIG. 4A; and

FIGS. 5 and 6 illustrate schematic views, showing a lamp, a supporting device, an elastic mechanism, and a printed circuit board being assembled at different stages in accordance with one embodiment of the present invention.

### DETAILED DESCRIPTION OF THE INVENTION

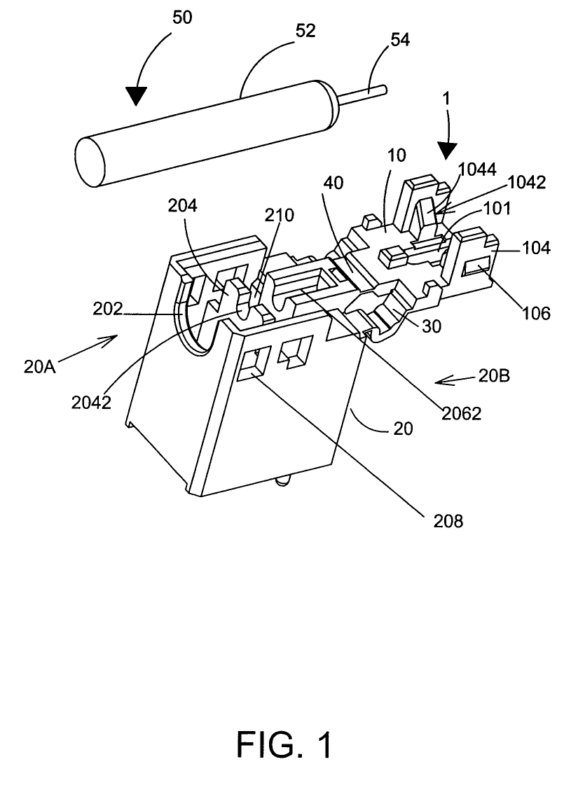

The present invention provides a backlight module, which is provided with a supporting device for sustaining a lamp and connecting the lamp with a printed circuit board, so that the assembly cost can be reduced and the product reliability and quality can also be improved. FIGS. 1-6 illustrate preferred embodiments of the present invention.

FIG. 1 illustrates a schematic view of a supporting device I in accordance with one embodiment of the present invention. As shown in FIG. 1, the supporting device 1 includes a first housing 10 and a second housing 20, which is foldably connected to the first housing 10. For example, the first housing 10 and the second housing 20 are foldably connected by a connection mechanism, such as 30, 40, which is flexible or bendable. Preferably, the first housing 10, the second housing 20, and the connection mechanism 30, 40 are integrally formed so as to eliminate the process of assembling three separate elements, such as the first housing, the second housing, and the connection mechanism, and reduce the cost.

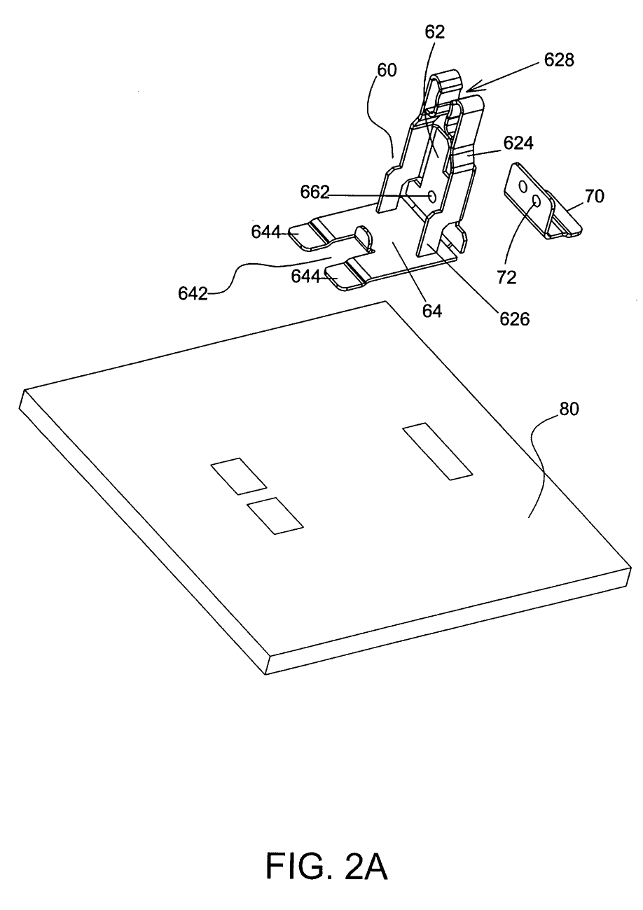

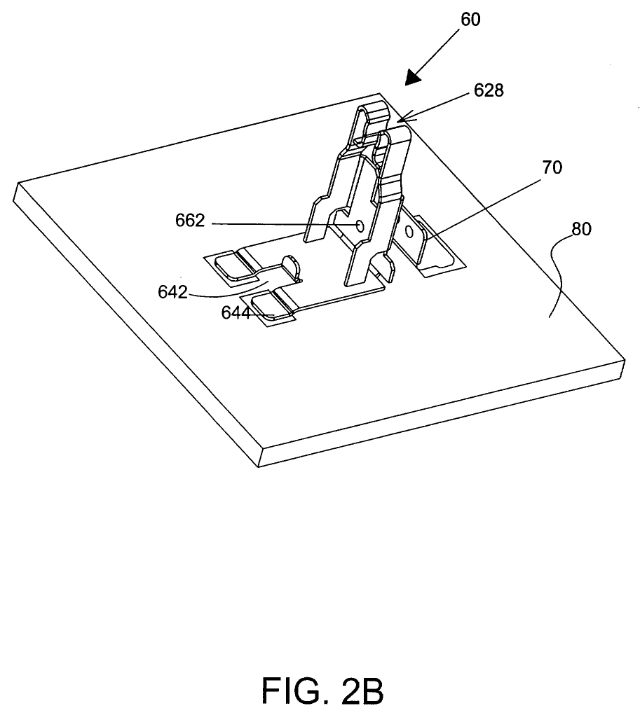

The first housing 10 includes a first groove 101 and at least one engaging part 104 is disposed adjacent to the first groove 101. For example, two engaging parts 104 are disposed on two opposite sides with respect to the first groove 101, and the engaging part 104 is embodied in a stepped shape. Please note the engaging part 104 may be designed with any appropriate shape with respective to the shape of the second housing 20. The engaging part 104 includes a protrusion block 1042 with a slant surface 1044 on a first side, such as an inner side. In this embodiment, two protrusion blocks 1042 are disposed face to face on two engaging parts 104, respectively. The engaging part 104 further includes a bulge portion 106 on a second side opposite to the protrusion block 1042. The bulge portion 106 is configured to engage with the second housing 20 when the first housing 10 and the second housing 20 are folded. For example, the second housing 20 includes a hole 208 on the side for engaging with the bulge portion 106 when the first housing 10 and the second housing 20 are folded. Furthermore, when the first housing 10 and the second housing 20 are folded, an elastic mechanism 60 (as shown in FIG. 2) disposed in the second housing 20 is compressed through the slant surface 1044 of the protrusion block 1042 so as to tightly clamp a lamp 50, as described below.

Also as shown in FIG. 1, the second housing 20 is formed with an opening 202 in the front end 20A for receiving the lamp 50. The second housing 20 further includes a stopper 204 for limiting the movement of the lamp 50 within the second housing 20. The stopper 204 is formed with a recess 2042, which corresponds to the opening 202 of the second housing 20. The second housing 20 may also include a groove 2062 on a rear end 20B to be aligned with the opening 202 and the recess 2042 for further accommodating the lamp 50. For example, when the lamp 50 is assembled with the supporting device 1, the main body 52 of the lamp 50 is supported by the second housing 20 in the opening 202, and the stopper 204 may touch against one end of the main body 52 to limit the movement of the lamp 50. The contact electrode 54 of the lamp 50 can be disposed through the recess 2042 of the stopper 204 and accommodated in the groove 2062. That is, the opening 202 may have an appropriate shape, such as a U shape, for accommodating the main body 52 of the lamp 50, while the recess 2042 and the groove 2062 may have a suitable size for accommodating the contact electrode 54 and further restrict the movement of the lamp 50.

As shown in FIG. 1, the stopper 204 is disposed between the front end 20A and the rear end 20B of the second housing 20 so that the opening 202, the recess 2042, and the groove 2062 are aligned sequentially. In such an arrangement, the supporting device 1 provides a multiple-supporting-point configuration so as to stably sustain the lamp 50 at a desired height level. Please note that a space 210 between the stopper 204 and the groove 2062 is provided for disposing the elastic mechanism 60.

FIG. 2A illustrates a schematic view of an exemplary elastic mechanism 60 and a printed circuit board 80 in accordance with one embodiment of the present invention. For a better understanding, the lamp 50, the first housing 10, and the second housing 20 are not shown. Referring to FIG. 2A, the elastic mechanism 60 includes an elastic portion 62 and a base portion 64 arranged in L shape. The elastic portion 62 is configured to clamp the lamp 50, and the base portion 62 is configured to be fixed on the printed circuit board 80. The elastic portion 62 may include two separate upper portions in “p” or “q” shapes arranged face to face to form an elastic portion in “pq” shape 622 so that the contact electrode 54 of the lamp 50 can be inserted into the two separate upper portions, such as into the gap 628 of the “pq” elastic portion 622. The lower part 624 of the elastic portion 62 can be connected to a support plate 66, which is provided to connect the elastic portion 62 with the base portion 64. The base portion 64 includes a fork like connection unit 644 in the front end, which is configured to connect with the printed circuit board 80, or any electronic component or device as appropriate. The elastic mechanism 60 is made of a conductive material, such as metal, so as to provide electrical connections between the lamp 50 and the printed circuit board 80.

As shown in FIG. 2A, the support plate 66 includes a mounting hole 662. When the elastic mechanism 60 is to be mounted on the printed circuit board 80, an auxiliary mounting plate 70 may be implemented to connect the elastic mechanism 60 and the printed circuit board 80. For example, screws may be used to engage with the mounting hole 662 of the support plate 66 and the hole 72 of the auxiliary mounting plate 70, and then the auxiliary mounting plate 70 can be mounted on the printed circuit board 80 by screws or welding. The elastic mechanism 60 can be connected to the printed circuit board 80 in any suitable manner so as to provide the electrical connection between the lamp 50 and the printed circuit board 80, as shown in FIG. 2B.

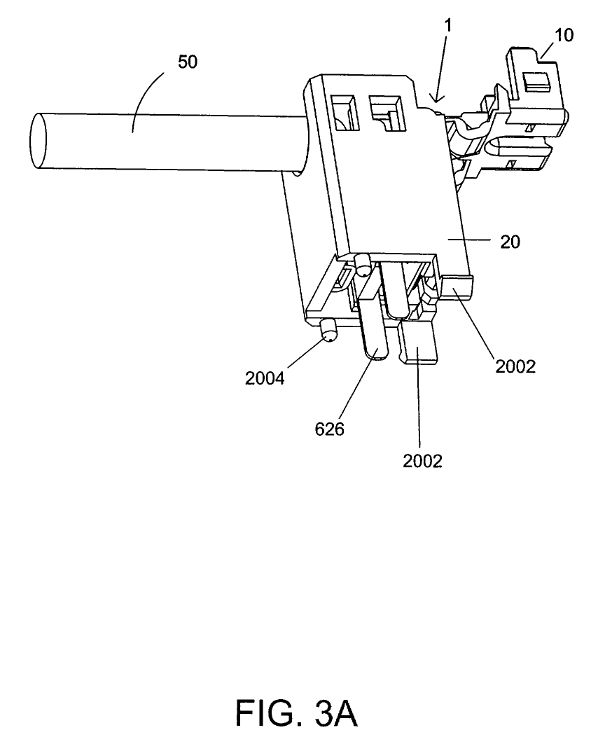

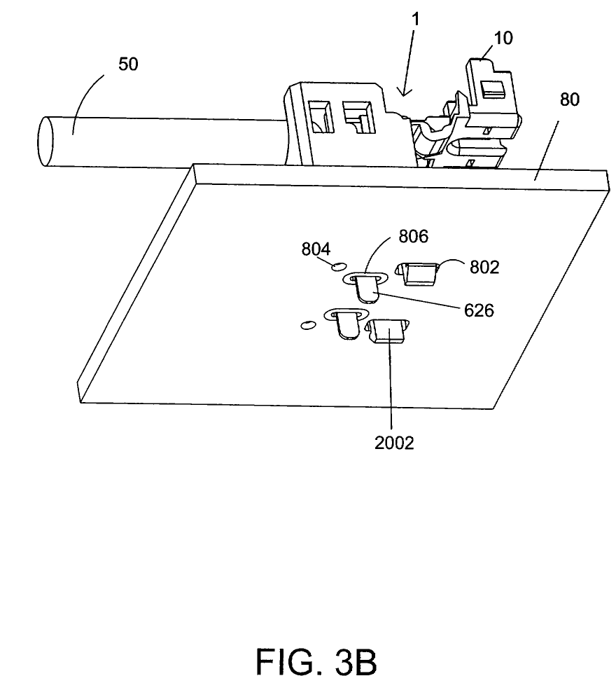

Referring to FIG. 3A and FIG. 3B, the elastic mechanism 60 and the second housing 20 may have different design in accordance with another embodiment of the present invention. FIG. 3A illustrates the lamp 50 assembled with the supporting device 1.

Different from the supporting device described above, the supporting device 1 includes a positioning mechanism for engaging with the printed circuit board 80. For example, the positioning mechanism may be embodied as a hook-like part 2002 and/or a positioning post 2004 disposed on a bottom surface of the second housing 20. In an exemplary embodiment, the positioning mechanism can be disposed on four corners or four sides of the bottom of the second housing 20 as appropriate. It is noted that the number and the position of the hook-like part 2002 or the positioning post 2004 may be varied with different design requirement. The positioning mechanism is provided to engaging with the positioning mechanism of the printed circuit board 80. For example, the hook-like part 2002 and the positioning post 2004 are engaged with the holes 802, 804 of the printed circuit board 80 so as to fix the supporting device 1 on the printed circuit board 80, as shown in FIG. 3B.

As shown in FIG. 3B, when the supporting device 1 mounted on the printed circuit board having holes 802, 804, the hook-like part 2002 is aligned and inserted into the hole 802 so as to engage the second housing 20 with the printed circuit board 80. Similarly, the positioning post 2004 is received in the hole 804 so as to further enhance the connection between the second housing 20 and the printed circuit board 80. Furthermore, in this embodiment, the elastic mechanism 60 includes an extension portion 626 extended from the elastic portion 62, which protrudes out of the second housing 20 for electrically coupling with the printed circuit board 80. For example, when the elastic mechanism 60 is assembled with the second housing 20, the extension portion 626 protrudes from the bottom of the second housing 20 into the hole 806 of the printed circuit board 80. The hole 806 may be a conductive hole for electrically coupling with the extension portion 626 by, for example, welding or other suitable manners. The hole 806 may be a non-conductive hole for the extension portion 626 passing through and to be electrically coupled with another contact region of the printed circuit board 80 by any suitable manner. When the base portion 64 with the connection unit 644 is provided, the based portion 64 may also be arranged on the printed circuit board 80 with the connection unit 644 electrically coupling to the printed circuit board 80 to further enhance the connection between the supporting device I and the printed circuit board 80. In such an arrangement, when the lamp 50 is clamped by the elastic mechanism 60, the lamp 50 can be electrically connected to the printed circuit board 80 with enhanced electrical and mechanical connection.

In comparison with the embodiments in FIG. 2B and FIG. 3B, with the design of the extension portion 626, the electrical connection among the lamp 50, the elastic mechanism 60, and the printed circuit board 80 can be readily achieved with/without the optional base portion 64.

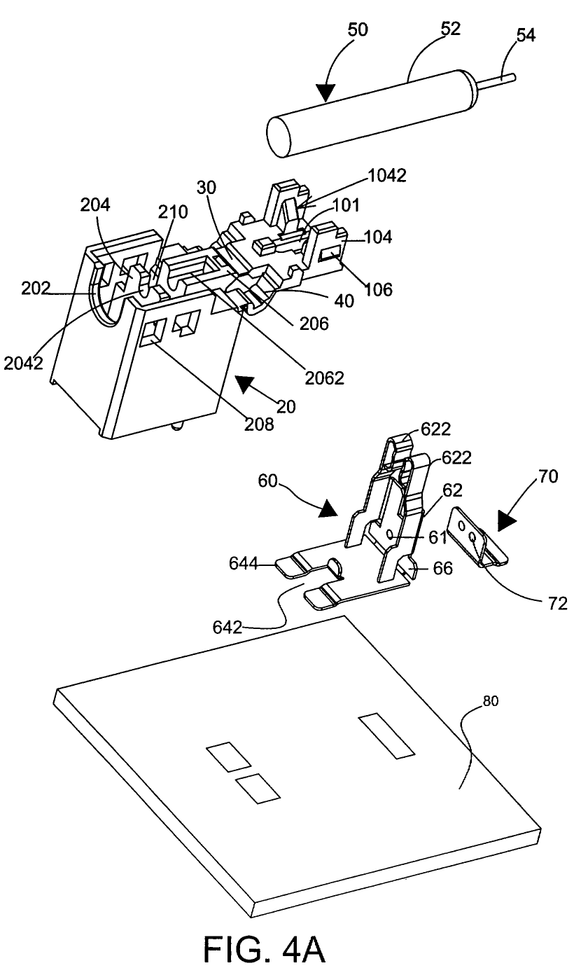

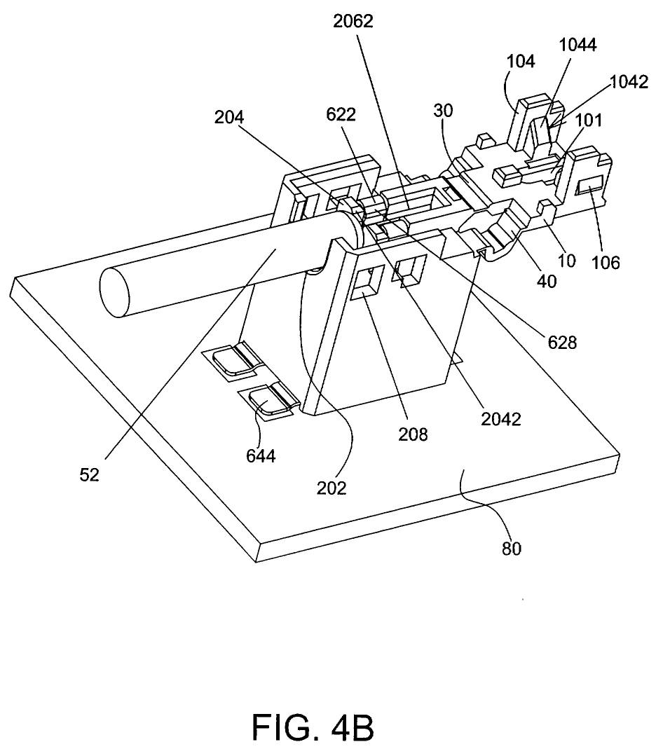

Referring to FIG. 4A and FIG. 4B, the assembly of a backlight module including a lamp, a supporting device, and a printed circuit board is illustrated. The supporting device 1 with the elastic mechanism 60 disposed in the second housing 20 is fixed on the printed circuit board 80 as described. The elastic mechanism 60 is disposed in the space 210 between the stopper 204 and the groove 2062 with the elastic portion 62, such as the “pq” portion 622, aligned with the recess 2042 and the groove 2062. The base portion 64 of the elastic mechanism 60 is arranged on the printed circuit board 80 with the connection unit 644 extended out the second housing 20 to electrically couple with the printed circuit board 80.

The lamp 50 is sustained by the supporting device 1 with the main body 52 carried in the opening 202 and against the stopper 204, while the connection electrode 54 passes through the recess 2042 of the stopper 204 inserted through the gap 628 of the “pq” potion 622 and received in the groove 2062, as shown in FIG. 4B. In such an arrangement, when the first housing 10 and the second housing 20 are folded, the engaging part 101 compresses the elastic mechanism 60 to electrically clamp the connection electrode 54 of the lamp 50.

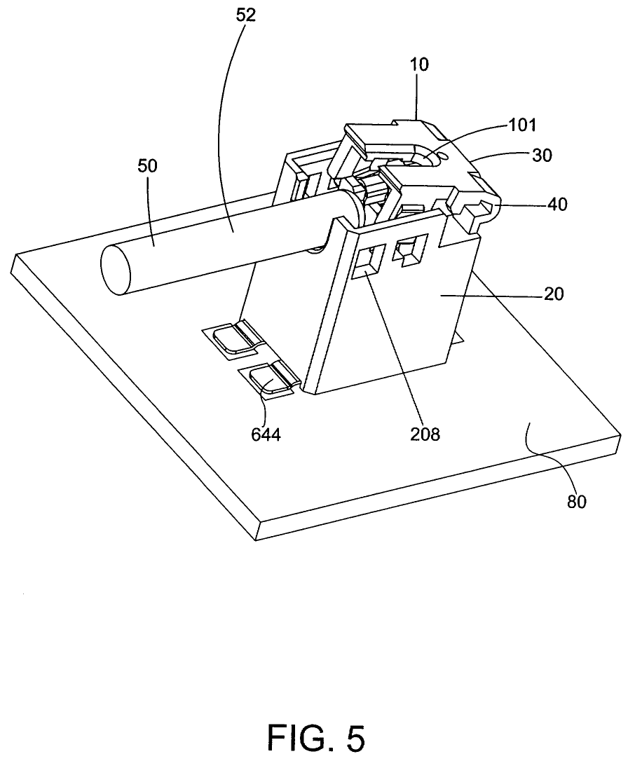

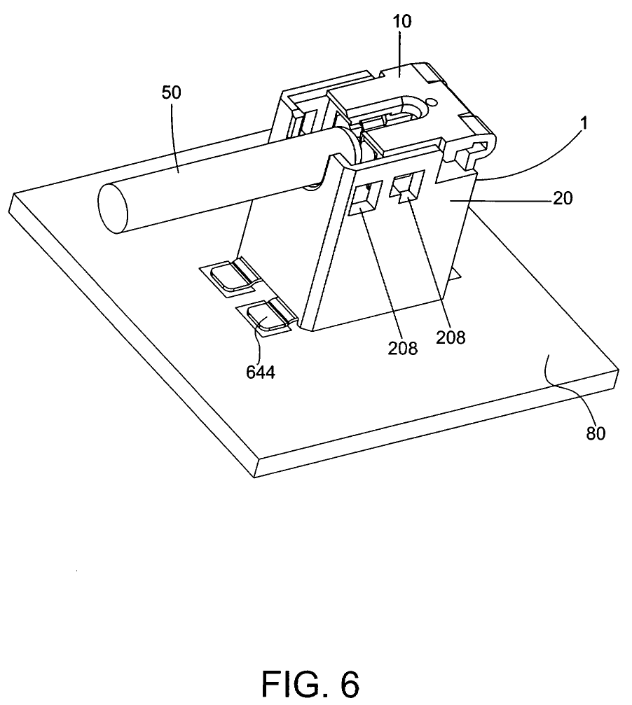

With reference to FIG. 5 and FIG. 6, the transition configuration and the folded configuration of the first housing and the second housing with the lamp sustained are illustrated. As show in FIG. 5, when the first housing 10 is pressed down toward the second housing 20, the slant surface 1044 of the protrusion block 1042 provided on one side of the engaging part 104 touches against the “pq” portion 622 of the elastic mechanism 60 so that the “pq” portion 622 is compressed. That is, the “pq” portion 622 of the elastic mechanism 60 is forced to contract and the gap 628 of “pq” portion 622 is minimized so as to tightly clamp the connection electrode 54 therein and achieve the electrical connection between the connection electrode 54 and the printed circuit board 80.

As shown in FIG. 6, when the first housing 10 and the second housing 20 are folded, the bulge portion 106 of the engaging part 104 is engaged with the hole 208 so as to enhance the folded configuration of the first housing 10 and the second housing 20 and prevent the connection electrode 54 from sliding out of the “pq” portion 622. In such an arrangement, the lamp 50 is stably and robustly electrically connected to the printed circuit board 80 through the implement of the elastic mechanism 60 with a simplified assembly procedure and a lower production cost.

Although specific embodiments have been illustrated and described, it will be obvious to those skilled in the art that various modifications may be made without departing from what is intended to be limited solely by the appended claims.

What is claimed is:

1. A supporting device for sustaining a lamp, comprising:
a first housing having an engaging part;
a second housing having an opening for receiving the lamp; and
an elastic mechanism disposed in the seconding housing, wherein the first housing and the second housing are foldably connected, and when the first housing and the second housing are folded, the engaging part compresses the elastic mechanism to electrically clamp the lamp.

2. The supporting device of claim 1, wherein the first housing and the second housing are foldably connected by a connection mechanism.

3. The supporting device of claim 2, wherein the connection mechanism is flexible.

4. The supporting device of claim 2, wherein the first housing, the second housing, and the connection mechanism are integrally formed.

5. The supporting device of claim 1, wherein the elastic mechanism comprises an extension portion protruding out of the second housing for electrically coupling with a printed circuit board.

6. The supporting device of claim 1, wherein the elastic mechanism comprises an elastic portion and a base portion arranged in L shape, the elastic portion is configured to clamp the lamp, and the base portion is configured to be fixed on a printed circuit board.

7. The supporting device of claim 1, wherein the engaging part comprises a protrusion block with a slant surface on a first side, and when the first housing and the second housing are folded, the elastic mechanism is compressed through the slant surface of the protrusion block so as to tightly clamp the lamp.

8. The supporting device of claim 7, wherein the engaging part further comprises a bulge portion on a second side opposite to the protrusion block, and the second housing has a hole for engaging with the bulge portion when the first housing and the second housing are folded.

9. The supporting device of claim 1, wherein the second housing further comprises a stopper for limiting the movement of the lamp within the second housing.

10. The supporting device of claim 1, wherein the second housing further comprises a groove corresponding to the opening for accommodating the lamp.

11. A backlight module, comprising:
a lamp;
a supporting device, comprising:
a first housing having an engaging part;
a second housing having an opening for receiving the lamp, the second housing being foldably connected with the first housing; and
an elastic mechanism disposed in the seconding housing; and
a printed circuit board electrically connected with the elastic mechanism,
wherein when the first housing and the second housing are folded, the engaging part compresses the elastic mechanism to clamp the lamp so that the lamp and the printed circuit board are electrically coupled.

12. The backlight module of claim 11, wherein the first housing and the second housing are foldably connected by a connection mechanism.

13. The backlight module of claim 12, wherein the connection mechanism is flexible.

14. The backlight module of claim 12, wherein the first housing, the second housing and the connection mechanism are integrally formed.

15. The backlight module of claim 11, wherein the elastic mechanism comprises an extension portion protruding out of the second housing for electrically coupling with a printed circuit board.

16. The backlight module of claim 11, wherein the elastic mechanism includes an elastic portion and a base portion arranged in L shape, the elastic portion is configured to clamp the lamp, and the base portion is configured to be fixed on a printed circuit board.

17. The backlight module of claim 11, wherein the engaging part comprises a protrusion block with a slant surface on a first side, and when the first housing and the second housing are folded, the elastic mechanism is compressed through the slant surface of the protrusion block so as to tightly clamp the lamp.

18. The backlight module of claim 17, wherein the engaging part further comprises a bulge portion on a second side opposite to the protrusion block, and the second housing has a hole for engaging with the bulge portion when the first housing and the second housing are folded.

19. The backlight module of claim 11, wherein the second housing further comprises a stopper for limiting the movement of the lamp within the second housing.

20. The backlight module of claim 11, wherein the second housing further comprises a groove corresponding to the opening for accommodating the lamp.

21. The backlight module of claim 11, wherein the printed circuit board comprises a first positioning mechanism, the second housing comprises a second positioning mechanism engaging with the first positioning mechanism so as to fix the second housing on the printed circuit board.
